(19) United States
(12) Patent Application Publication
(10) Pub. No.: US 2011/0101925 A1
(43) Pub. Date: May 5, 2011

(54) FEEDBACK-ADJUSTABLE CHARGING SYSTEM AND METHOD THEREOF

(75) Inventor: WEI-CHIH LAI, TAIPEI COUNTY (TW)

(73) Assignees: INVENTEC APPLIANCES (SHANGHAI) CO. LTD., Shanghai (CN); INVENTEC APPLIANCES CORP., TAIPEI COUNTY (TW)

(21) Appl. No.: 12/913,030

(22) Filed: Oct. 27, 2010

(30) Foreign Application Priority Data
Nov. 4, 2009 (CN) 200910208360.X

(51) Int. Cl. H02J 7/04

(52) U.S. Cl. 320/162

(57) ABSTRACT

The present invention provides a feedback-adjustable charging system applicable to a rechargeable electronic device and a method thereof. The feedback-adjustable charging system comprises a converter module, an adjustable voltage module and maybe a connective module. The converter module is coupled to an AC power supply and is used for converting AC power from the AC power supply into DC power. The adjustable voltage module is coupled to the converter module for receiving the DC power and producing a voltage used for charging. The connective module is coupled to the electronic device and the adjustable voltage module for receiving and transmitting the charging voltage to the electronic device and for producing a feedback parameter to the adjustable voltage module. In the charging system, the adjustable voltage module is used to adjust a value of the charging voltage according to the feedback parameter.

### BACKGROUND OF THE INVENTION

1. Field of the Invention

The present invention relates to a charging system and a method thereof, and more particularly to a feedback-adjustable charging system and a method thereof.

2. Description of Related Art

As science and technology advance, electronic products such as mobile phones, MP3 players, PDA, digital cameras, and the like available in the market are used extensively. Almost everyone has one in hand, and these electronic products become very popular. However, the battery standby time of the electronic products is very limited. If the battery is low, it is necessary to charge the battery by a battery charger. Users generally possess more than one electronic device, and some even carry two mobile phones with them. If the two mobile phones are of different brands or specifications, then users have to carry a corresponding number of chargers or backup batteries with them, and it is a burden for users to carry so many accessories with them. Obviously, it is troublesome and inconvenient. Since most of the electronic products have different specifications, it is rather impossible to have a universal charger for charging the electronic products. Consumers generally throw away the old charger when they purchase a new product, thereby incurring a waste of resources. In addition, most people usually dump the old chargers away without any recycle, thus jeopardizing our environment. Obviously, the aforementioned problems required improvements.

Most chargers available in the market adopt a fixed voltage to charge the electronic device. For example, a fixed voltage of 5V is used for the USB charging. If the charger has to supply a larger current to charge an electronic device, the larger current will be transmitted through a conductive wire to the electronic device, but the conductive wire has an internal resistance. According to the Ohm's law, if the larger current is one ampere and the internal resistance is one ohm, a potential difference of 1V will be generated between the charger and the electronic device. According to the definition of electric power P=IV, the current can be reduced if the voltage is increased. According to the definition of heat quantity, a joule is equal to the amount of heat energy produced by passing a current of one ampere through a resistance of one ohm for a second. Large heat loss will expedite aging an insulating layer wrapped around the conductive wire, and the damaged insulating layer may cause accidents such as electric fire. Therefore, if the current passing through the conductive wire could be reduced, the heat loss should be lowered so as to slow the aging rate of the insulating layer.

In view of the aforementioned shortcomings of the prior art, the inventor of the present invention based on years of experience in the related industry to conduct extensive researches and experiments, and finally developed a feedback-adjustable charging system and a method thereof to overcome the shortcomings of the prior art.

### SUMMARY OF THE INVENTION

In view of the aforementioned problems of the prior art, an object of the present invention is to provide a feedback-adjustable charging system and a method thereof which can be applicable for charging all kinds of electronic devices and reducing the phenomenon of wire heating caused by heat loss.

The present invention provides a feedback-adjustable charging system applicable to a rechargeable electronic device. The feedback-adjustable charging system comprises a converter module, an adjustable voltage module and a connective module. The converter module is coupled to an alternating-current (AC) power supply and is used for converting AC power from the AC power supply into direct-current (DC) power. The adjustable voltage module is coupled to the converter module for receiving the DC power and producing a voltage used for charging. The connective module is coupled to the electronic device and the adjustable voltage module for receiving and transmitting the charging voltage to the electronic device and for producing a feedback parameter to the adjustable voltage module. And in this feedback-adjustable charging system, the adjustable voltage module is used to adjust a value of the charging voltage according to the feedback parameter.

In the above-mentioned feedback-adjustable charging system, the connective module may further comprise an impedance unit. In this case, the feedback-adjustable charging system may further comprise a comparison module coupled to two terminals of the impedance unit for measuring a voltage difference between the two terminals and producing the feedback parameter, according to the voltage difference, to the adjustable voltage module.

In the feedback-adjustable charging system, the impedance unit may comprise a resistor.

In the feedback-adjustable charging system, the comparison module may comprise a comparator or a microprocessor.

In the feedback-adjustable charging system, the connective module may be electrically coupled to the adjustable voltage module by a wire or a circuit.

The present invention also provides a feedback-adjustable charging system, applicable to a rechargeable electronic device, which comprises a converter module, an adjustable voltage module, and a transmission port. The converter module is used for receiving and converting alternating-current (AC) power into direct-current (DC) power. The adjustable voltage module is coupled to the converter module for receiving the DC power and producing a voltage used for charging to the electronic device. The transmission port is coupled to the electronic device and the adjustable voltage module, for transmitting a feedback parameter, produced by the electronic device according to the charging voltage, to the adjustable voltage module. And in this feedback-adjustable charging system, the adjustable voltage module is used to adjust a value of the charging voltage according to the feedback parameter.

In this feedback-adjustable charging system, the electronic device may comprise a storage module, and the feedback parameter is stored in the storage module.

This feedback-adjustable charging system may further comprise a processing module coupled between the adjustable voltage module and the electronic device, for receiving the feedback parameter and adjusting a value of the charging voltage according to the feedback parameter.

In this feedback-adjustable charging system, the charging voltage may be transmitted to a power management unit of the electronic device.

In this feedback-adjustable charging system, the feedback parameter may be a voltage parameter.

The present invention also provides a charging method using feedback-adjustable voltage to charge a rechargeable electronic device. The charging method comprises the following steps. First, alternating-current (AC) power is converted into direct-current (DC) power. The DC power is then received to produce a voltage used for charging, and the charging voltage is outputted to the electronic device through an impedance unit. The voltage difference between two terminals of the impedance unit is then measured for producing a feedback parameter according to the voltage difference. Then it's determined whether to adjust a value of the charging voltage according to the feedback parameter.

In the charging method, the impedance unit may comprise a resistor.

In the charging method, the measuring step may be performed by a comparator or a microprocessor.

### BRIEF DESCRIPTION OF THE DRAWINGS

FIG. 1 shows a block schematic diagram of a feedback-adjustable charging system in accordance with a first preferred embodiment of the present invention;

FIG. 2 shows a block schematic diagram of a feedback-adjustable charging system in accordance with a second preferred embodiment of the present invention;

FIG. 3 shows a block schematic diagram of a feedback-adjustable charging system in accordance with a third preferred embodiment of the present invention; and

FIG. 4 shows a flow chart of a charging method using feedback-adjustable voltage to charge a rechargeable electronic device in accordance with the present invention.

### DETAILED DESCRIPTION OF THE PREFERRED EMBODIMENTS

The following description illustrates, with reference to the related drawings, preferred embodiments of the feedback-adjustable charging system and the charging method thereof for the present invention. The modifier “feedback-adjustable” is used herein to mean that the charging system is adjustable by feedback. To facilitate the understanding of the description, the same reference indicators will be used throughout the drawings and the following detailed description to refer to the same parts.

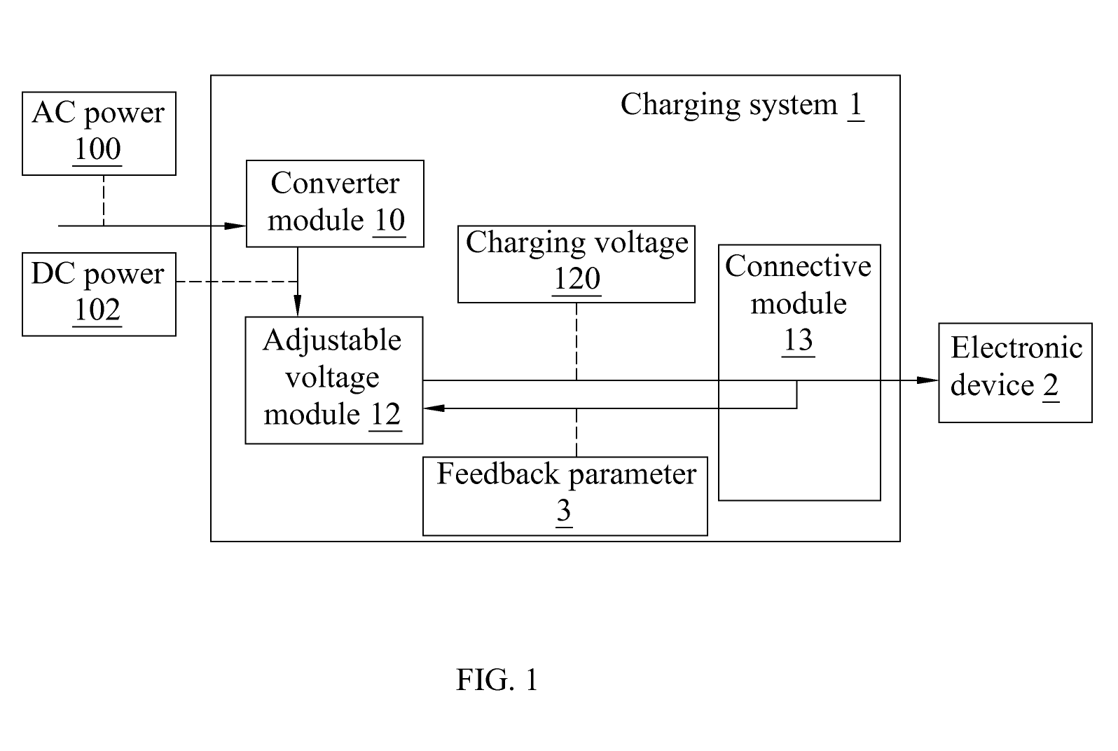

Referring to FIG. 1 showing a block schematic diagram of a feedback-adjustable charging system in accordance with a first preferred embodiment of the present invention, the charging system 1 comprises a converter module 10, an adjustable voltage module 12 and a connective module 13. The following will describe in detail the embodiment of the present invention.

The charging system 1 is mainly capable of charging a rechargeable electronic device 2. In the charging system 1, the converter module 10 is coupled to an alternating-current (AC) power supply and for converting AC power 100 from the AC power supply into direct-current (DC) power 102, which is transmitted to the adjustable voltage module 12. It may be that the converter module 10 converts the AC power 100 into the DC power 102. The adjustable voltage module 12 is coupled to the converter module 10 for receiving the DC power 102 and thus producing a voltage 120 used for charging. It may be that the adjustable voltage module 12 receives the DC power 102 and thus produces the charging voltage 120. The connective module 13 is coupled to the electronic device 2 and the adjustable voltage module 12 for receiving and transmitting the charging voltage 120 to the electronic device 2. It also may be that the connective module 13 receives and transmits the charging voltage 120 to the electronic device 2. In the charging system 1, the electronic device 2 may be a portable electronic device, and the connective module 13 may be electrically coupled to the adjustable voltage module 12 by a wire or a circuit.

When the electronic device 2 is being charged by the charging system 1, a feedback parameter 3 can be produced by the connective module 13 and then transmitted back to the adjustable voltage module 12. The adjustable voltage module 12 is used to or can adjust a value of the charging voltage 120 according to the feedback parameter 3 such that the overheating phenomenon of the wire or circuit between the adjustable voltage module 12 and the connective module 13 could be avoided, and the value of the charging voltage 120 can be consistent with a voltage value required by the electronic device 2. At the same power output, the higher the voltage, the lower the current. Moreover, according to the principle of conversion of electrical energy into heat energy, when the current is lowered, the heat loss will be reduced. Therefore, not only the charging system 1 can satisfy the charging need of the electronic device 2, but also it can be avoided that the wire connected between the charging system 1 and the electronic device 2 is overloaded due to over high-current.

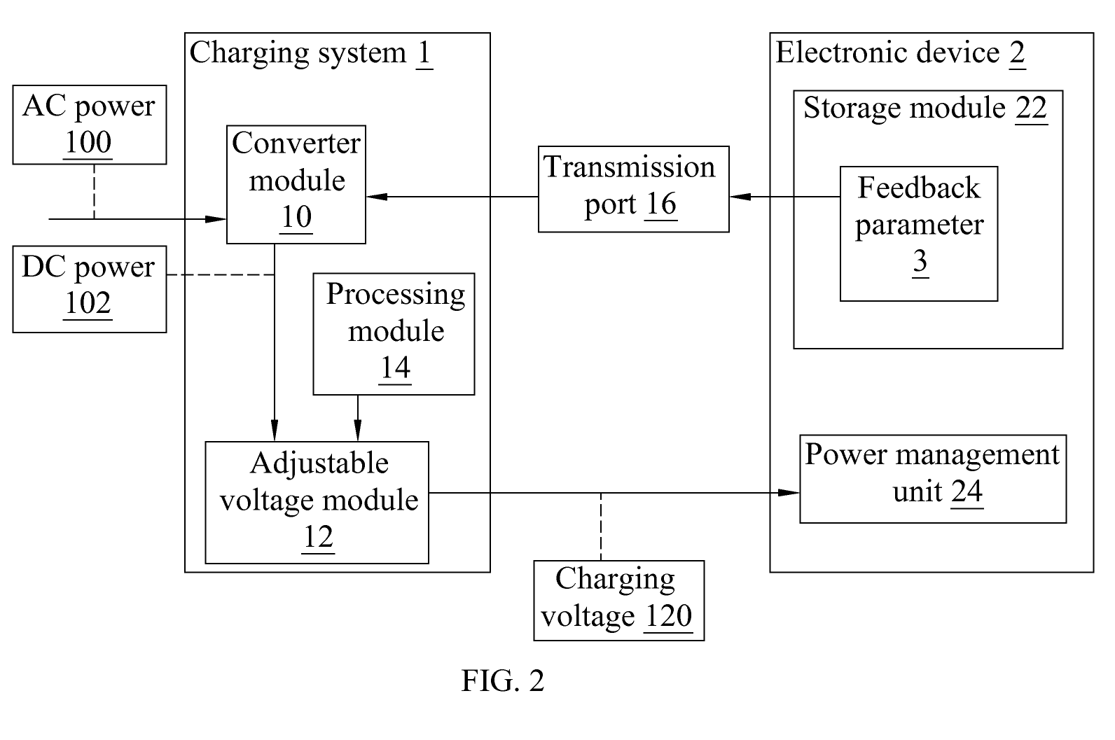

Referring to FIG. 2 showing a block schematic diagram of a feedback-adjustable charging system in accordance with a second preferred embodiment of the present invention, the components in this embodiment which are the same as the components in the first preferred embodiment will not be described again, but the description will be mainly focused on only their differences. In FIG. 2, the electronic device 2 may further comprise a storage module 22 and a power management unit 24, and the charging system 1 may further comprise a processing module 14 and a transmission port 16. Compared to the first embodiment, the charging voltage 120 is directly transmitted to the electronic device 2 by the adjustable voltage module 12 without using the connective module 13 in the second embodiment.

The feedback parameter 3 can be recorded and stored in advance by the storage module 22. While the electronic device 2 is being charged by the charging system 1, the feedback parameter 3 can be transmitted to the processing module 14 by the storage module 22 via the transmission port 16. The processing module 14 can control the operation of the adjustable voltage module 12 according to the feedback parameter 3. The adjustable voltage module 12 is used to adjust a value of the charging voltage 120 and transmit the charging voltage 120 to the power management unit 24 of the electronic device 2 for charging. Wherein, the transmission port 16 may be, but is not limited to, an 12C (Inter-Integrated Circuit) port or a SPT (Serial Peripheral Interface) port. The feedback parameter 3 may be a voltage parameter.

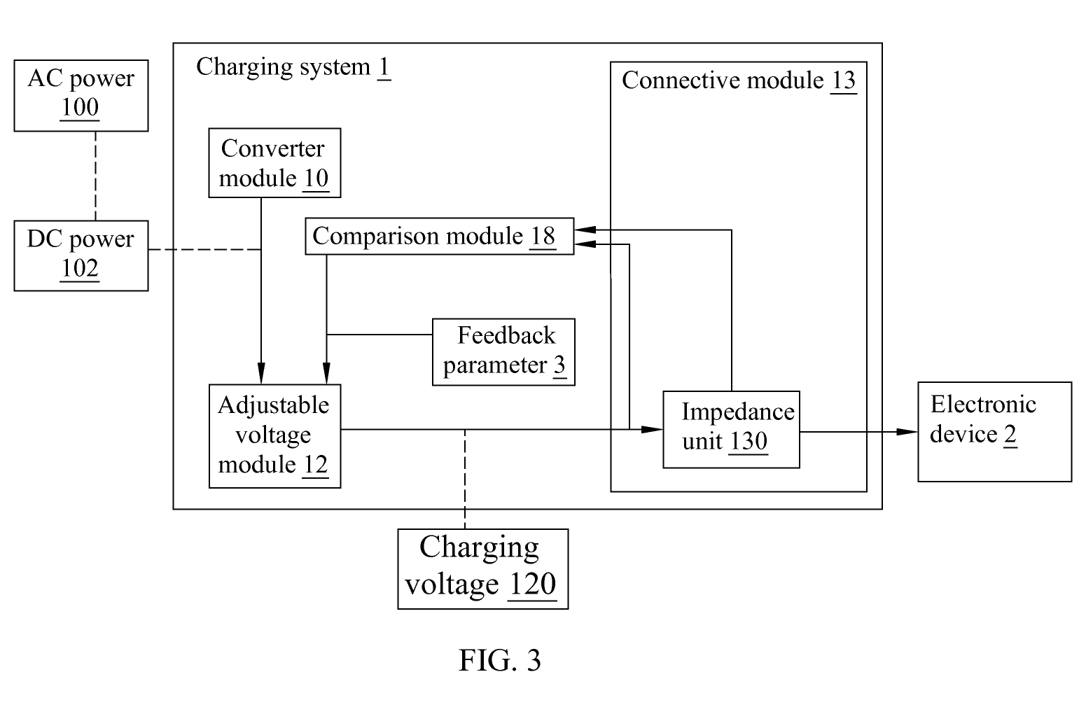

Referring to FIG. 3 showing a block schematic diagram of a feedback-adjustable charging system in accordance with a third preferred embodiment of the present invention, the charging system 1 comprises a converter module 10, an adjustable voltage module 12 and a comparison module 18, and the connective module 13 comprises an impedance unit 130. The following will describe in detail this embodiment of the present invention.

The charging system 1 in FIG. 3 is mainly capable of charging a rechargeable electronic device 2. In the charging system 1, the converter module 10 is coupled to an alternating-current (AC) power supply and for converting AC power 100 from the AC power supply into direct-current (DC) power 102, which is transmitted to the adjustable voltage module 12. It may be that the converter module 10 converts the AC power 100 into the DC power 102. After receiving the DC power 102, the adjustable voltage module 12 coupled to the converter module 10 can output a voltage 120 used for charging to the connective module 13. The connective module 13 is electrically coupled to the electronic device 2 such that the charging voltage 120 can be transmitted to the electronic device 2. The comparison module 18 may be electrically coupled to two terminals of the impedance unit 130 for measuring a voltage difference between the two terminals and thus producing the feedback parameter 3, according to the voltage difference, to the adjustable voltage module 12. The feedback parameter 3 may be a voltage parameter. The adjustable voltage module 12 is used to or can adjust a value of the charging voltage 120 according to the feedback parameter 3. Finally, the charging voltage 120 is transmitted to the electronic device 2 by the connective module 13. In the charging system 1, the impedance unit 130 may be a resistor, and the comparison module 18 may be a comparator or a microprocessor.

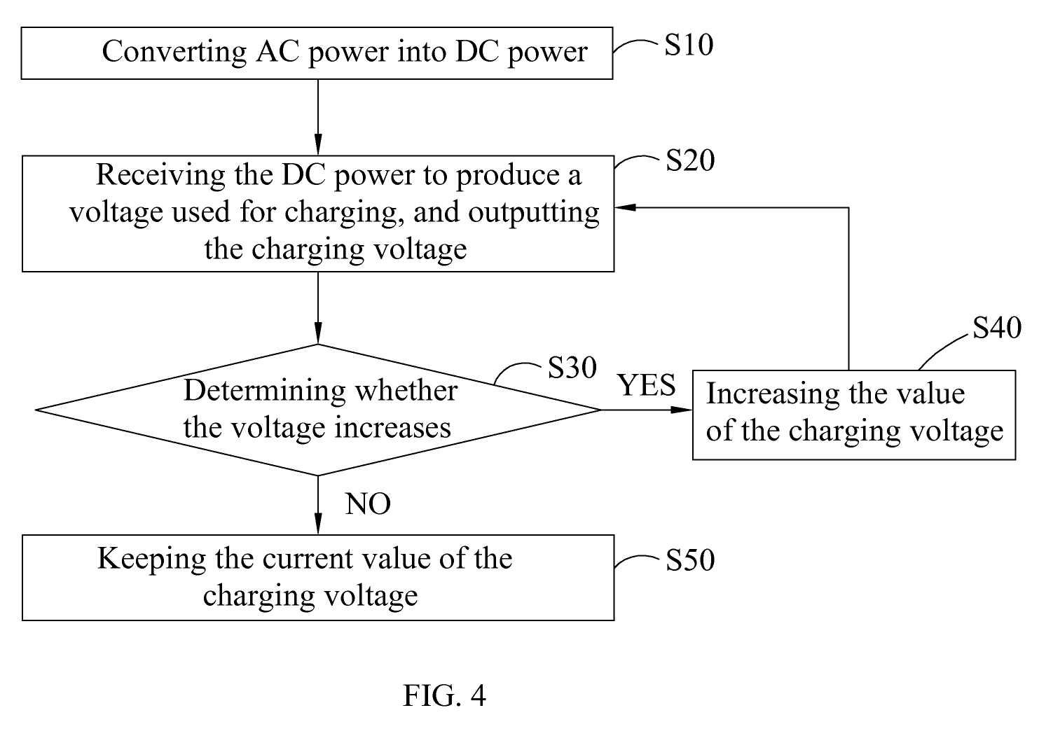

Referring to FIG. 4 showing a flow chart of a charging method using feedback-adjustable voltage to charge a rechargeable electronic device in accordance with the present invention, the charging method includes the following steps, which are described as when they are performed on e.g. the charging system 1. First, in step S10, alternating-current (AC) power 100 is converted into direct-current (DC) power 102, which is outputted by e.g. the charging system 1. In step S20, the DC power 102 is received by e.g. the adjustable voltage module 12 to produce a voltage 120 used for charging, and then the charging voltage 120 is outputted to the electronic device through an impedance unit 130, which may be included in the connective module 13. The impedance unit 130 may be a resistor, and the connective module 13 may be electrically coupled to the adjustable voltage module 12 by a wire or a circuit. Then in step S30, a voltage difference between two terminals of the impedance unit 130 is measured for producing a feedback parameter 3 according to the voltage difference, wherein the measuring step may be performed by the comparison module 18 electrically coupled to two terminals of the impedance unit 130. The produced feedback parameter 3 may be received by the adjustable voltage module 12. Then it's determined, e,g. by the adjustable voltage module 12, whether to adjust a value of the charging voltage 120 according to the feedback parameter 3. If the determination is positive, then in step S40 the value of the charging voltage 120 is increased, followed by returning back to the step S20, where the voltage difference between the two terminals of the impedance unit 130 is measured again. If the determination is negative, then in step S50 the current value of the charging voltage 120 is maintained. Further, the step S30 may be performed by a comparator or a microprocessor. And the feedback parameter 3 may be a voltage parameter.

In view of the above embodiments, the feedback-adjustable charging system and the charging method thereof according to the present invention may have, without being limited to, one or more of the following advantages. The first one is that the feedback-adjustable charging system and the charging method thereof can prevent the connecting wire between the charging system and the charged electronic device from overheating. The second one is that the feedback-adjustable charging system and the charging method thereof can be used to adjust a value of the charging voltage according to the needs of different electronic device.

The above-mentioned exemplary embodiments are illustrative only and are not intended to be in any way limiting. While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiments of the present invention.

What is claimed is:

1. A feedback-adjustable charging system applicable to a rechargeable electronic device, comprising:
a converter module, coupled to an alternating-current (AC) power supply, and for converting AC power from the AC power supply into direct-current (DC) power;
an adjustable voltage module, coupled to the converter module, for receiving the DC power and producing a voltage used for charging; and
a connective module, coupled to the electronic device and the adjustable voltage module, for receiving and transmitting the charging voltage to the electronic device, and for producing a feedback parameter to the adjustable voltage module;
wherein the adjustable voltage module is used to adjust a value of the charging voltage according to the feedback parameter.

2. The feedback-adjustable charging system of claim 1, wherein the connective module further comprises an impedance unit.

3. The feedback-adjustable charging system of claim 2, further comprising a comparison module coupled to two terminals of the impedance unit, for measuring a voltage difference between the two terminals and producing the feedback parameter, according to the voltage difference, to the adjustable voltage module.

4. The feedback-adjustable charging system of claim 3, wherein the impedance unit comprises a resistor.

5. The feedback-adjustable charging system of claim 3, wherein the comparison module comprises a comparator or a microprocessor.

6. The feedback-adjustable charging system of claim 1, wherein the connective module is electrically coupled to the adjustable voltage module by a wire or a circuit.

7. A feedback-adjustable charging system applicable to a rechargeable electronic device, comprising:
a converter module for receiving and converting alternating-current (AC) power into direct-current (DC) power;
an adjustable voltage module, coupled to the converter module, for receiving the DC power and producing a voltage used for charging to the electronic device; and
a transmission port, coupled to the electronic device and the adjustable voltage module, for transmitting a feedback parameter, produced by the electronic device according to the charging voltage, to the adjustable voltage module;
wherein the adjustable voltage module is used to adjust a value of the charging voltage according to the feedback parameter.

8. The feedback-adjustable charging system of claim 7, wherein the electronic device comprises a storage module, and the feedback parameter is stored in the storage module.

9. The feedback-adjustable charging system of claim 7, further comprising a processing module coupled between the adjustable voltage module and the electronic device, for receiving the feedback parameter and adjusting a value of the charging voltage according to the feedback parameter.

10. The feedback-adjustable charging system of claim 7, wherein the charging voltage is transmitted to a power management unit of the electronic device.

11. The feedback-adjustable charging system of claim 7, wherein the feedback parameter is a voltage parameter.

12. A charging method using feedback-adjustable voltage to charge a rechargeable electronic device, comprising the steps of:
converting alternating-current (AC) power into direct-current (DC) power;
receiving the DC power to produce a voltage used for charging, and outputting the charging voltage to the electronic device through an impedance unit;
measuring a voltage difference between two terminals of the impedance unit for producing a feedback parameter according to the voltage difference; and
determining whether to adjust a value of the charging voltage according to the feedback parameter.

13. The charging method of claim 12, wherein the impedance unit comprises a resistor.

14. The charging method of claim 12, wherein the measuring step is performed by a comparator or a microprocessor.
